(19) United States
(12) Patent Application Publication
(10) Pub. No.: US 2005/0066739 A1
(43) Pub. Date: Mar. 31, 2005

(54) Method and apparatus for wafer mechanical stress monitoring and wafer thermal stress monitoring

(75) Inventors: Yehiel Gotkis, Fremont, CA (US); Rodney Kistler, Los Gatos, CA (US); Aleksander Owczarz, San Jose, CA (US); David Hemker, San Jose, CA (US); Nicolas J. Bright, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: LAM RESEARCH CORPORATION

(21) Appl. No.: 10/671,978

(22) Filed: Sep. 26, 2003

(51) Int. Cl. G01L 1/00

(52) U.S. Cl. 73/760

(57) ABSTRACT

A chemical mechanical planarization (CMP) system is provided. The CMP system includes a wafer carrier configured to support a wafer during a planarization process, the wafer carrier including a sensor configured to detect a signal indicating a stress being experienced by the wafer during planarization. A computing device in communication with the sensor is included. The computing device is configured to translate the signal to generate a stress map for analysis. A stress relief device responsive to a signal received from the computing device is included. The stress relief device is configured to relieve the stress being experienced by the wafer.

### CROSS REFERENCE TO RELATED APPLICATION

This application is related to U.S. patent application Ser. No. 10/463,256, entitled “METHOD AND APPARATUS FOR APPLYING DIFFERENTIAL REMOVAL RATES TO A SURFACE OF A SUBSTRATE,” filed on Jun. 18, 2003. This application is incorporated herein by reference in its entirety for all purposes.

### BACKGROUND OF THE INVENTION

The invention relates generally to semiconductor fabrication and more specifically to in-line metrology for process control during wafer processing.

During semiconductor fabrication, the substrate is exposed to localized stress conditions. With respect to Chemical Mechanical Planarization (CMP) operations, where the planarization is achieved by a topography selective chemical mechanical process that includes revolving steps of mechanical surface activation, localized thermal and mechanical stress regions may occur during the processing.

Monitoring thermal conditions at the wafer/pad interaction interface has become more important with the introduction of chemically active slurries. Since the chemical etching is exponentially sensitive to the thermal conditions, a single hot spot on the surface of the wafer may adversely impact the wafer surface quality. Additionally, monitoring mechanical load conditions at the wafer/pad interaction interface has also become important with the introduction of non-Prestonian slurries. Moreover, with respect to low-k dielectrics applications, a single aggressive spot over the polishing interface may have dire consequences for process quality. For example, the aggressive spot may cause peeling, corrosion, scratching, and excessive dishing and erosion.

In view of the foregoing, there is a need to provide a method and apparatus that is capable of monitoring the stress conditions experienced by the wafer and is configured to institute corrective actions to relieve the stress condition.

### SUMMARY OF THE INVENTION

Broadly speaking, the present invention fills these needs by providing a method and apparatus capable of generating stress maps corresponding to thermal and mechanical stress conditions experienced by a substrate during a processing operation. Additionally, the embodiments described below are capable of initiating corrective action to relieve the detected stress condition. It should be appreciated that the present invention can be implemented in numerous ways, including as an apparatus, a system, a device, or a method. Several inventive embodiments of the present invention are described below.

In accordance with one embodiment, a chemical mechanical planarization (CMP) system is provided. The CMP system includes a wafer carrier configured to support a wafer during a planarization process, the wafer carrier including a sensor configured to detect a signal indicating a stress being experienced by the wafer during planarization. A computing device in communication with the sensor is included. The computing device is configured to translate the signal to generate a stress map for analysis. A stress relief device responsive to a signal received from the computing device is included. The stress relief device is configured to relieve the stress being experienced by the wafer.

In another embodiment, a chemical mechanical planarization (CMP) system capable of monitoring thermal stress associated with a substrate being processed is provided. The CMP system includes a wafer carrier having a plurality of sensors, each of the sensors configured to detect a signal corresponding to a temperature of a region of the substrate. A computing device is in communication with the plurality of sensors. The computing device is configured to generate a thermal map of the substrate from the signal. The computing device is capable of analyzing data associated with the thermal map to identify any region of the substrate experiencing thermal stress. A stress relief device responsive to the computing device is included. The stress relief device is triggered to relieve the thermal stress when the computing device identifies any region of the substrate experiencing thermal stress.

In accordance with yet another embodiment, a chemical mechanical planarization (CMP) system capable of monitoring mechanical stress associated with a substrate being processed is provided. The CMP system includes a wafer carrier having a sensor configured to detect a signal indicative of a mechanical load experienced by a corresponding location on the substrate during processing. A computing device is in communication with the sensor. The computing device is configured to generate a mechanical stress map of the substrate from the signal. The computing device is capable of analyzing data associated with the mechanical stress map to identify a region of the substrate experiencing mechanical stress. This information may be used for hardware, which in turn may translate the information for process optimization, troubleshooting and quality control purposes. For example, a system or device responsive to the computing device, may be triggered to adjust a process parameter in order to relieve the mechanical stress or adjust a parameter to optimize the use/lifetime of a process consumable, e.g., slurry, polishing pad, etc. Additionally, the information may be used to design a future tool in a manner to eliminate the identified stress regions.

In accordance with still yet another embodiment, a process development tool configured to monitor stress conditions experienced by a substrate during semiconductor processing operations is provided. The process tool includes a sensor configured to monitor a signal indicative of a stress experienced by a substrate during processing operations within the process development tool. A computing device is in communication with the sensor. The computing device is configured to create a stress map from the signal. The computing device is further configured to analyze the stress map to identify any stressed regions of the substrate so that the computing device may initiate an activity that provides relief to the stressed region.

In accordance with another embodiment, a method for monitoring and relieving stress conditions associated with a substrate during a chemical mechanical planarization (CMP) process is provided. The method initiates with monitoring a signal corresponding to a stress condition. Then, a stress map which corresponds to the substrate, is generated from the monitoring of the signal. Next, the stress map is analyzed. Then, a region of a surface of the substrate experiencing the stress condition is identified. Next, the CMP process is adjusted to relieve the stress condition.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a graph illustrating traces of eddy current sensor signals over time for a chemical mechanical planarization operation.

FIG. 2 is a graph illustrating the corresponding traces of three infrared sensors over time.

FIG. 3 is an expanded view of a portion of FIGS. 1 and 2 superimposed over each other to clearly illustrate the periodic modulation associated with the eddy current sensor and the infrared sensor.

FIG. 4 is a graph illustrating the traces from FIG. 3 in which a pure sine trace and a delta sine trace have been added for comparison purposes.

FIG. 5 is a graph of an expanded section of FIG. 4.

FIGS. 6A through 6D illustrate thermal stress maps generated from signals detected by an infrared sensor in accordance with one embodiment of the invention.

FIG. 7 illustrates an average of the thermal maps illustrated in FIGS. 6A through 6D.

FIG. 8 illustrates the thermal map of FIG. 7 which has been aligned due to the rotation of a wafer carrier supporting the substrate.

FIG. 9 is a simplified schematic diagram of a wafer carrier having an eddy current sensor and an infrared sensor disposed therein in accordance with one embodiment of the invention.

FIGS. 10A and 10B illustrate a stress map generated through signals detected by an eddy current sensor in accordance with one embodiment of the invention.

FIG. 11 is a simplified schematic diagram of a system capable of monitoring and analyzing mechanical and thermal stress experienced by a substrate in accordance with one embodiment of the invention.

FIG. 12A is a simplified schematic diagram of a chemical mechanical planarization system configured to monitor stresses experienced by a substrate undergoing planarization processing and adjust processing parameters to relieve the stress condition in accordance with one embodiment of the invention.

FIG. 12B is a simplified schematic diagram of an alternative embodiment of the chemical mechanical planarization system of FIG. 12A.

### DETAILED DESCRIPTION OF THE PREFERRED EMBODIMENTS

Several exemplary embodiments of the invention will now be described in detail with reference to the accompanying drawings. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

Eddy current sensors (ECS) allow for measuring a metal film thickness of a moving wafer. The ECS is also capable of functioning as a proximity sensor. Infrared sensors are capable of providing contact-less surface temperature monitoring for a wafer being processed. The embodiments of the present invention provide for real-time contact-less monitoring of stress conditions created through thermal or mechanical conditions. In one embodiment, the thermal stress distribution across a wafer is mapped and monitored. The thermal stress distribution is analyzed in order to initiate corrective action to relieve the thermal stress. In another embodiment, mechanical load conditions experienced by a wafer are mapped and monitored during the processing operation. A map of the mechanical stress conditions is analyzed in order to initiate corrective action to relieve the mechanical stress. Of course, the stress maps may be used for process optimization purposes also.

The embodiments discussed herein, are discussed with reference to chemical mechanical planarization schemes applied to a wafer, also referred to as a substrate. It should be appreciated that the embodiments may be applied to any suitable semiconductor processing operation where it is desirable to understand the mechanical and thermal stress conditions associated with the processing of the wafer. In addition, the embodiments described herein may be applied for monitoring and qualifying the status of consumables, e.g., slurry, polishing pad, etc., under processing conditions.

In one embodiment, a CMP system that includes differential closed loop control for sensing and correcting stress conditions experienced by a wafer undergoing a planarization operation is provided. The system includes a wafer carrier disposed over a polishing pad. The wafer carrier is configured to support a wafer during a planarization process. The wafer carrier includes at least one sensor configured to detect a signal corresponding to a stress condition being experienced by the wafer. A general purpose computer in communication with the sensor is included. The general purpose computer is configured to store the signal and create a stress map from the signal. In one embodiment, a plurality of sensors provide signals for the subsequent creation of a stress map. As will be explained in more detail below, the stress map may be analyzed, and resulting from the analysis, corrective action to reduce the stress associated with a certain high stress region is initiated. The corrective action may be applied differentially as described in more detail below. Alternatively, the embodiments described herein may be used as a process development tool to identify stress conditions for a processing tool and apply solutions to alleviate those conditions during the development phase of the tool.

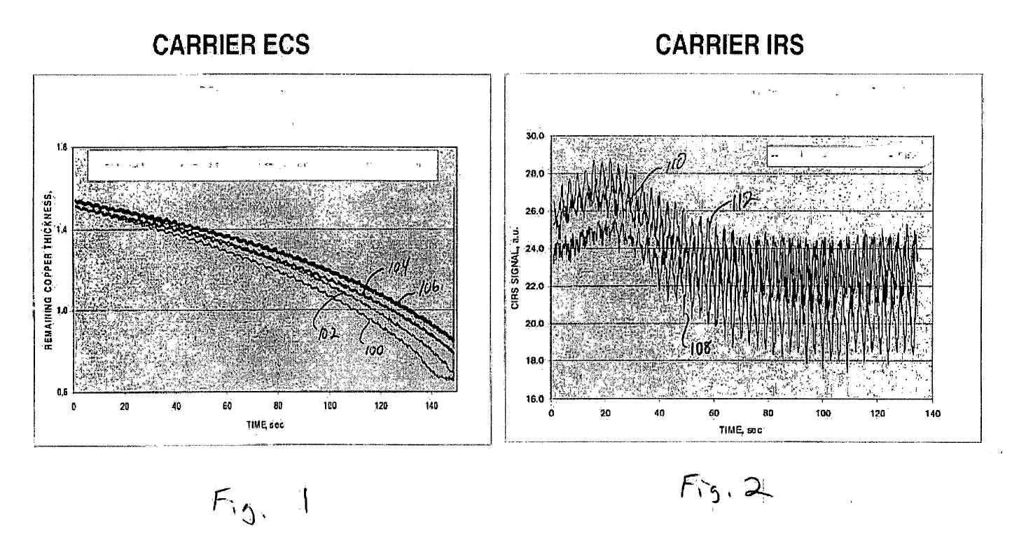

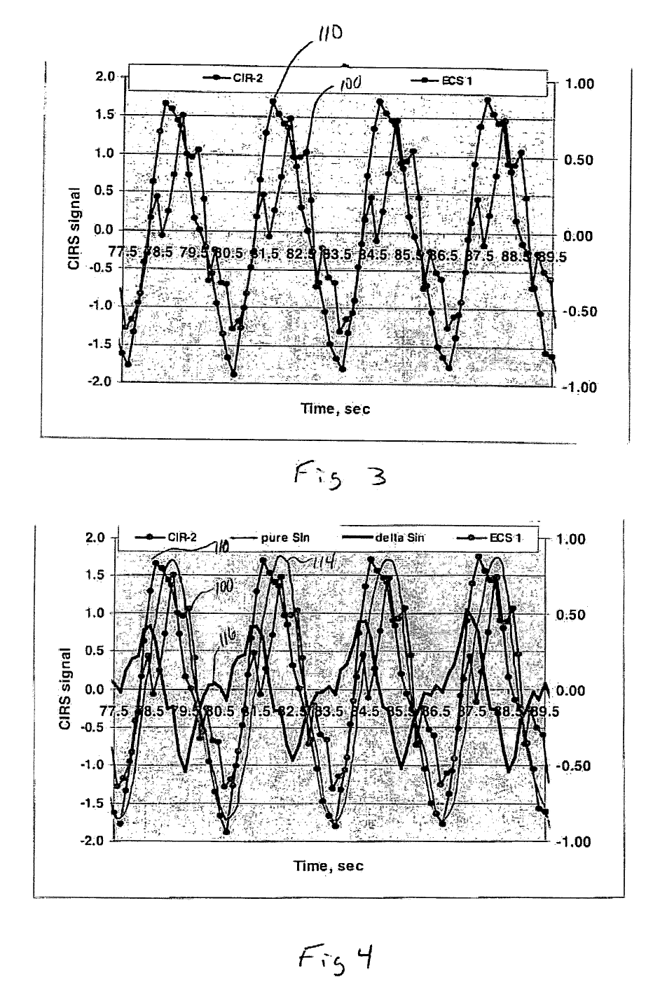

FIG. 1 is a graph illustrating traces of eddy current sensor signals over time for a chemical mechanical planarization operation. Here, four eddy current sensors and their associated signals are illustrated by lines 100, 102, 104, and 106. As can be seen, there is a modulation component in the trace for each of the eddy current sensors. As will be explained further with reference to FIGS. 3-5, the modulation component exhibits a periodic pattern associated with structure of the wafer being planarized.

FIG. 2 is a graph illustrating the corresponding traces of three infrared sensors over time. Here, lines 108, 110, and 112 represent the infrared signal over time. Similar to the ECS signal traces of FIG. 1, the infrared signal traces exhibits a modulation component that exhibits a periodic pattern.

FIG. 3 is an expanded view of a portion of FIGS. 1 and 2 superimposed over each other to clearly illustrate the periodic modulation associated with the eddy current sensor and the infrared sensor. For exemplary purposes, lines 100 and 110 are shown in FIG. 3. As can be seen in FIG. 3, lines 100 and 110 exhibit a sinusoidal type of pattern that is repetitive.

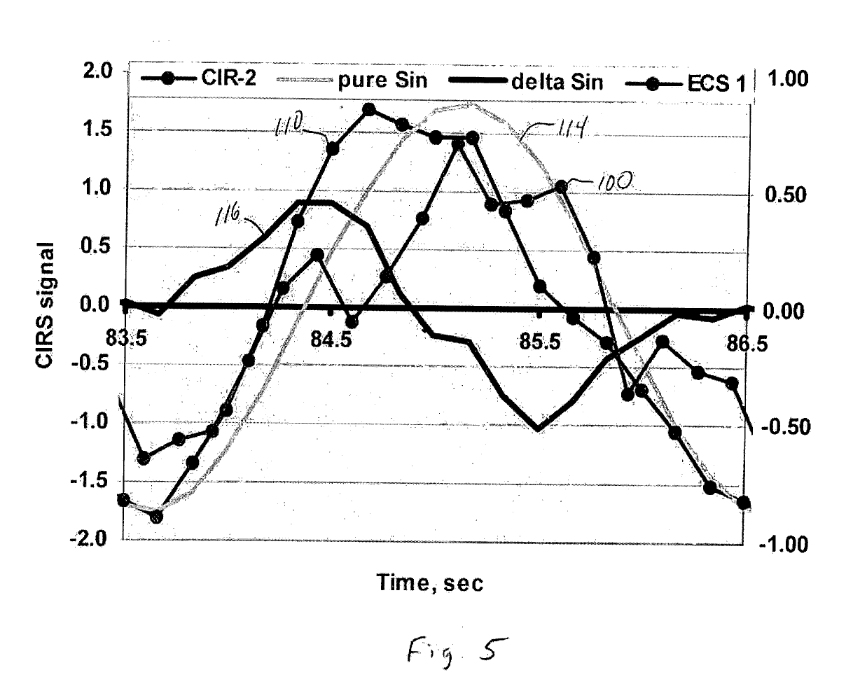

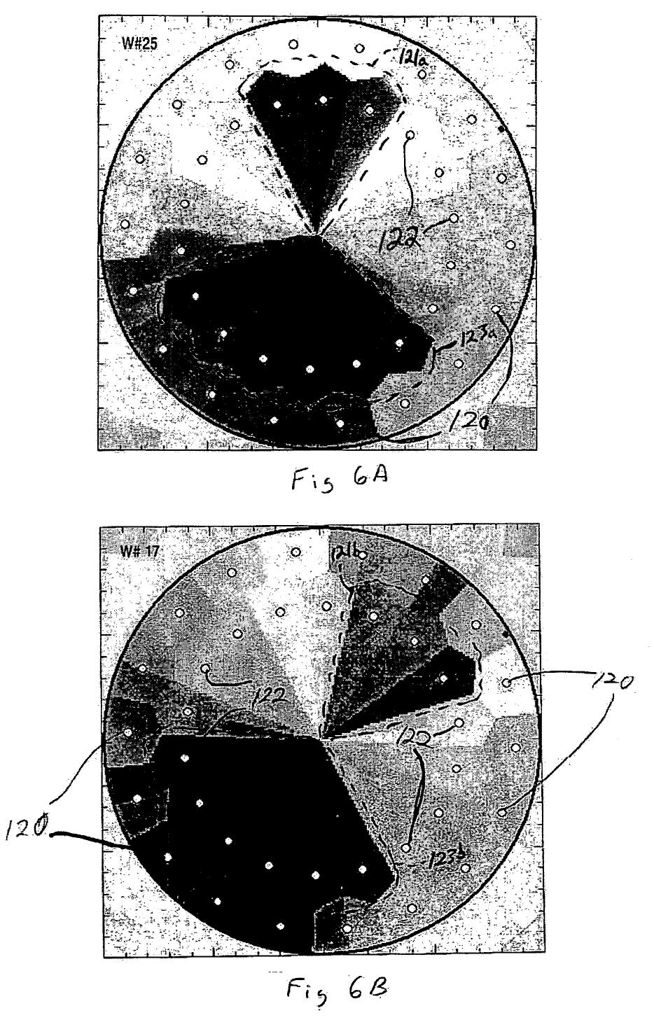

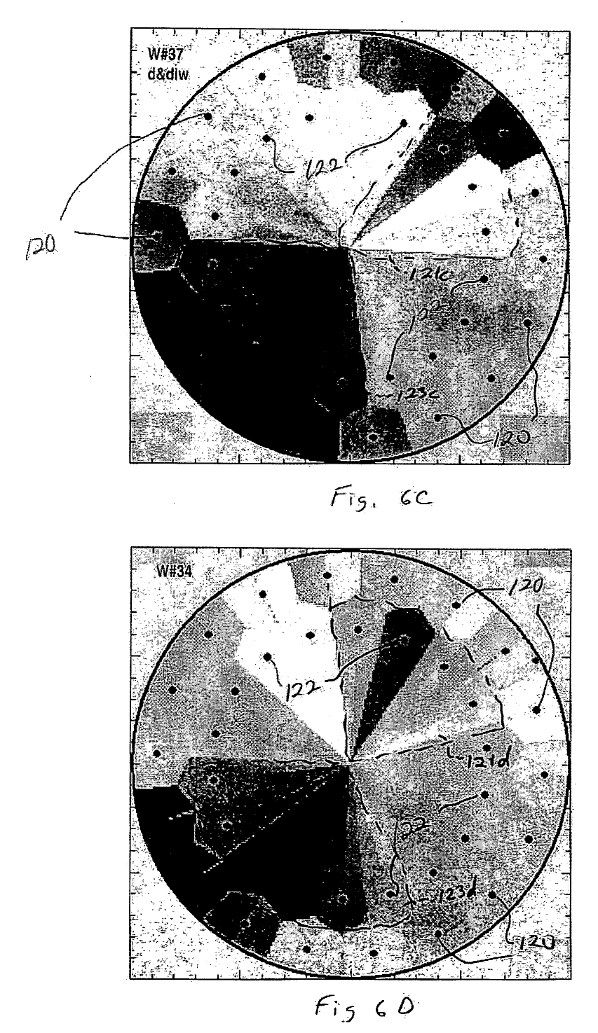

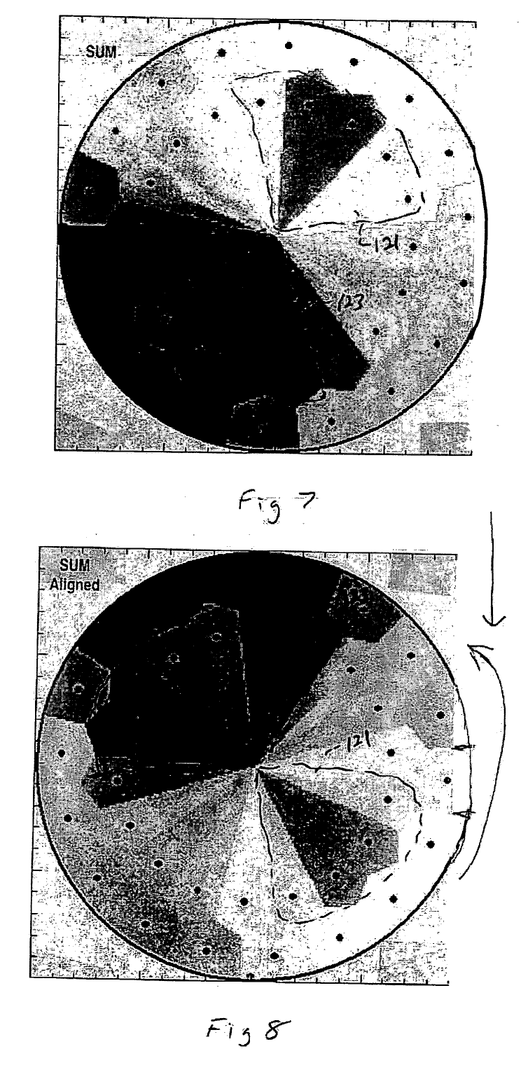

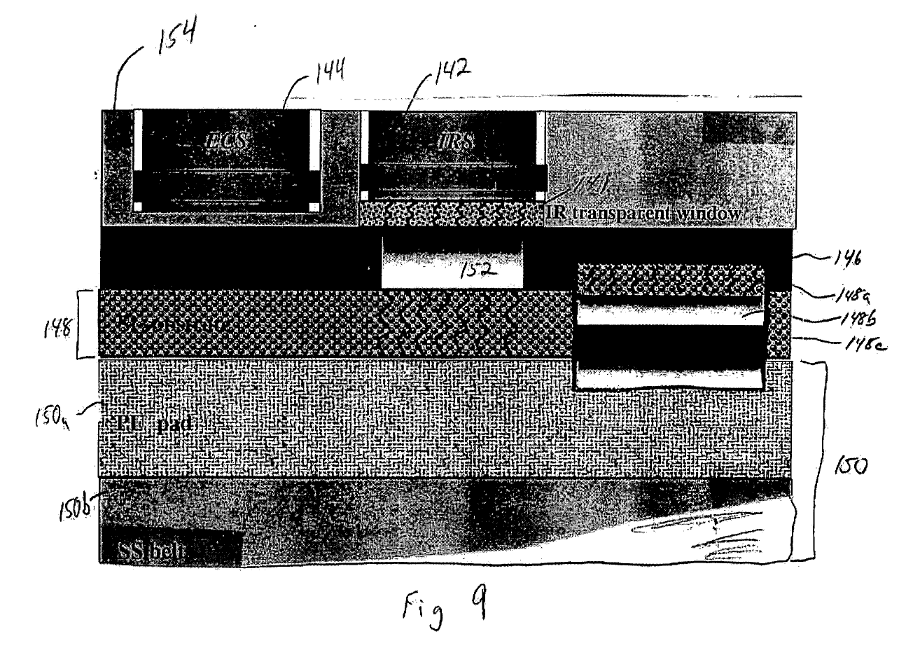

FIG. 4 is a graph illustrating the traces from FIG. 3 in which a pure sine trace and a delta sine trace have been added for comparison purposes. As can be seen in FIG. 4, the infrared trace is slightly offset from pure sine trace 114. It should be appreciated that this phenomenon is indicative of multi-component makeup of the infrared trace 110. Thus, subtracting infrared trace 110 with pure sine trace 114 yields the delta sine trace 116. As can be seen, delta sine trace 116 is offset by approximately 90° from pure sine trace 114. The multi-component system, i.e., the rotational component due to the wafer carrier rotating and the linear component due to the belt over which the wafer carrier is disposed, accounts for this behavior. FIG. 5 is a graph of an expanded section of FIG. 4. Here, trace 100, 110, 114 and 116 are all illustrated showing a portion of one period. The approximate 90 degree offset of delta sine trace 116 and pure sine trace 114 is more clearly illustrated here.

FIGS. 6A through 6D illustrate thermal stress maps generated from signals detected by an infrared sensor in accordance with one embodiment of the invention. Here, locations 120 on the outer edge of each of the substrate outlines of FIG. 6A through 6D correspond to locations being monitored by one or more infrared sensors disposed within the carrier head. Locations 122, which are closer to the center of each of the substrates of FIGS. 6A through 6D, relative to location 120, are detected by one or more additional infrared sensors. As can be seen by comparing each of the thermal maps generated in FIGS. 6A through 6D, a similarity in the thermal distribution arises. Regions 121a-121d of each of these maps illustrate higher temperature regions of the substrate while the regions 123a-123d illustrate cooler temperature regions of the corresponding substrate. As can be seen, higher temperature regions 121a-121d are in the same general area of the substrate surface, as are cooler temperature regions 123a-123d.

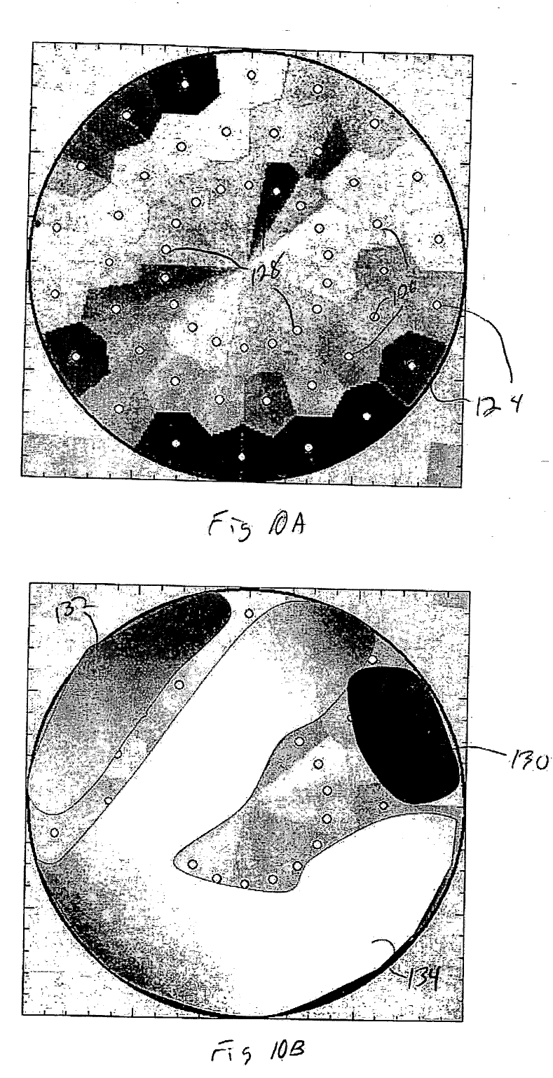

FIG. 7 illustrates an average of the thermal maps illustrated in FIGS. 6A through 6D. Here, region 121 is an average of regions 121a-121d, while region 123 is an average of region 123a-123d. FIG. 8 illustrates the thermal map of FIG. 7 which has been aligned due to the rotation of a wafer carrier supporting the substrate. It should be appreciated that infrared signal is delayed, thereby causing a phase shift in a dynamic system. FIG. 9, which is a simplified schematic diagram of a wafer carrier having an eddy current sensor and an infrared sensor disposed therein in accordance with one embodiment of the invention, is used to explain the delay in more detail. Polishing pad 150 includes top polishing pad 150a disposed over stainless steel belt 150b. Substrate 148 is supported against carrier film 146, which is affixed to carrier 154. Infrared sensor 142 detects an infrared signal from substrate 148 during the planarization process. The infrared signal that is detected is generated at the interface of substrate 148 and polishing pad 150. In one embodiment, substrate 148 includes copper layer 148c disposed over dielectric layer 148b, which in turn is disposed over silicon substrate 148a. It should be appreciated that the infrared signal passes through substrate 148 instantaneously, as silicon substrate 148a is essentially transparent to infrared energy. Cavity 152 is filled with deionized water, which slows down the progression of the infrared energy, as the wafer takes time to heat. The infrared energy subsequently passes through infrared transparent window 141 and is detected by infrared sensor 142. Thus, the infrared signal detected by sensor 142 is slightly delayed as opposed to eddy current sensor 144 which senses the signal substantially instantaneously. Accordingly, as the wafer is being rotated, the mapping of the location on the substrate being monitored must be aligned to account for the delay and the rotation of the wafer.

Returning back to FIG. 8, the delay caused due to the infrared energy traversing the cavity filled with deionized water, causes about a 1 second delay, in one exemplary CMP system. This one second delay corresponds to a carrier rotation of about 120 degrees. Thus, FIG. 8 illustrates the average representation of FIG. 7 with regions 121 and 123 realigned to account for this delay. It should be appreciated that due to the relative velocity from the wafer rotating counterclockwise and the polishing pad linearly moving from the leading edge (top) of the wafer to the trailing edge (bottom) of the wafer, region 121 experiences a higher relative velocity and a higher temperature. On the other hand, region 123 experiences a lower relative velocity. It will be apparent to one skilled in the art that the alignment correction may differ for different CMP tools. Thus, the 120 degree alignment is meant to be exemplary and not limiting.

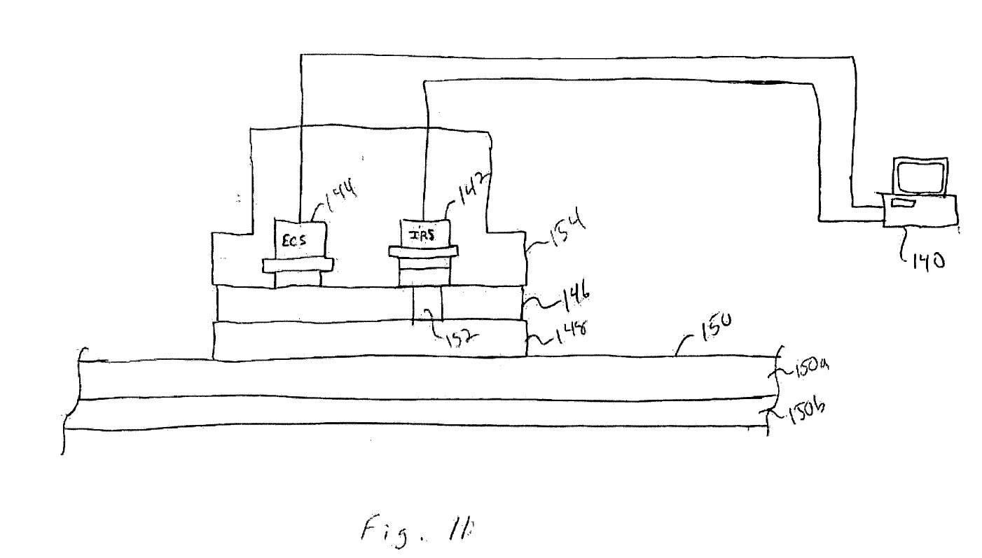

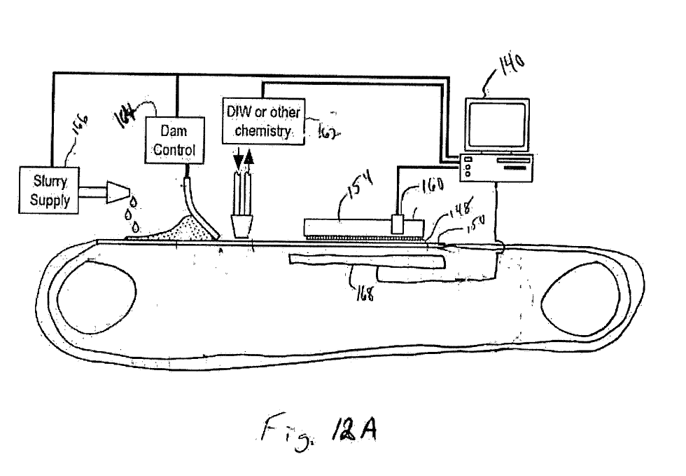

FIGS. 10A and 10B illustrate a mechanical stress map generated through signals detected by an eddy current sensor in accordance with one embodiment of the invention. Here, three sets of eddy current sensors are used to detect signals corresponding to concentric sample 124, 126, and 128 on the wafer. Through the analysis of the generated mechanical stress map of FIG. 10A, stress regions 130, 132 and 134 are identified in FIG. 10B. Stress region 132 corresponds to a high mechanical stress region. Stress region 134 indicates a relatively low stress region, while stress region 130 indicates a stress region which is between the stress experienced in regions 132 and 134. Here, the circular wafer being rotated over a rectangular polishing pad creates the configuration of the stress regions. The forces at work here include the stretching stress from the wafer being supported by the wafer carrier, the rotation of the supported wafer against the moving polishing pad, in addition to the forces associated with the leading and trailing edges of the wafer as the wafer is planarized.

Referring back to FIG. 1, the periodic modulation of the ECS traces is associated with the mechanical stress variation experienced by the wafer under processing conditions. Thus, a suitable proximity sensor, e.g.; an ECS, may be used to monitor the mechanical stress distribution across the wafer/pad interaction interface in order to generate the mechanical stress map of FIG. 10B. For example, as a bump, or some other distortion on the wafer surface passes within the detection region of the proximity sensor, this distortion is captured and translated to a mechanical stress and mapped. It should be appreciated that as the bump on the wafer will cause the carrier film to distort or compress. This compression is captured through the ECS. That is, the force compressing the carrier film is the same force being applied to the wafer surface. Therfore, the rotational modulation component of the ECS signal, as illustrated in FIGS. 1, 3, and 4, may be used to construct the wafer stress map.

Where the wafer includes a low-k dielectric, a single aggressive spot over the polishing interface may adversely affect process quality by causing peeling, corrosion, scratching, excessive dishing and/or erosion, etc., through the mechanical stress generated. Moreover, the monitoring of the stress conditions becomes important for CMP applications where non-Prestonian slurries are being used. In one embodiment, the stress map is analyzed and through the analysis, the process may be optimized or adjusted to relieve an identified stress region. That is, the mechanical stress map, similar to the thermal stress map, may be used to identify process optimizations for relief of the identified stress condition whether the optimization be associated with a consumable state, temperature and composition of the slurry, by products deposited over the polishing surface, topography of the polishing surface, etc. Other suitable processing parameters, such as downforce being applied, speed of the polishing pad, rotational speed of the carrier, etc., may also be optimized through the information available from analysis of the stress map.

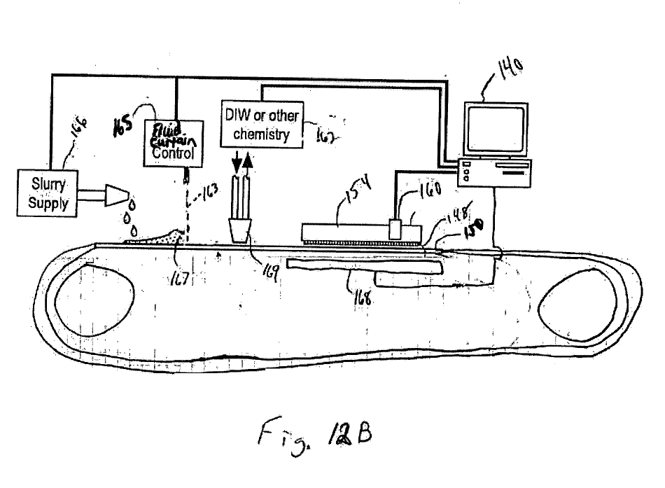

FIG. 11 is a simplified schematic diagram of a system capable of monitoring and analyzing mechanical and thermal stress experienced by a substrate in accordance with one embodiment of the invention. Wafer carrier 154 includes infrared sensor 142 and eddy current sensor 144. Carrier pad 146 includes an infrared window 152 in order for infrared signals to pass. Substrate 148 is supported against carrier pad 146. Substrate 148 is planarized by applying a downforce against the substrate, thereby forcing the substrate against polishing pad 150, which is composed of polishing pad layer 150a and stainless steel belt 150b. The signals detected by eddy current sensor 144 and infrared sensor 142 are transmitted to computing device 140. Computing device 140 is capable of generating a thermal stress map and a mechanical stress map as illustrated in FIGS. 6A through 6D and 10A and 10B, respectively. As will be discussed further with reference to FIGS. 12A and 12B, computing device 140 may then control or adjust processing conditions in order to relieve a stress that has been identified as being experienced by substrate 148. It should be appreciated that multiple eddy current sensors and multiple infrared sensors may be embedded within the wafer carrier in order to provide a more detailed stress map, as illustrated in FIGS. 6A through 6D and 10A and 10B. It should be further appreciated that the embodiments described herein refer to a linear polishing pad for illustrative purposes only and is not meant to be limiting. That is, an orbital CMP system or any other suitable CMP system may include the embodiments discussed herein.

FIG. 12A is a simplified schematic diagram of a chemical mechanical planarization system configured to monitor stresses experienced by a substrate undergoing planarization processing and adjust processing parameters to relieve the stress condition in accordance with one embodiment of the invention. Here, computing device 140 is in communication with a number of modules controlling and monitoring processing conditions experienced by substrate 148. For example, computing device 140 interfaces with the deionized water supply module 162, dam control module 164, slurry supply module 166 and air bearing 168. Thus, through the analysis of a stress map, generated for either thermal or mechanical purposes, computing device 140 may adjust any one of the previously mentioned modules in order to relieve the stress.

Still referring to FIG. 12A, wafer carrier 154 includes sensor 160. It should be appreciated that sensor 160 may be either a proximity sensor, e.g., an eddy current sensor, or a suitable temperature monitoring sensor, e.g., an infrared sensor as discussed with reference to FIG. 11. In addition, multiple sensors of one or both of the proximity and/or infrared sensor types may be disposed throughout wafer carrier 154. Substrate 148 is supported by wafer carrier 154 and planarized by a down force applied from the wafer carrier against polishing pad 150. Air bearing 168 creates a force to support polishing pad 150 as the substrate is forced against the top surface of the polishing pad. Thus, the rotational speed of wafer carrier 154, the linear velocity of belt 150, the down force exerted by wafer carrier 154, the amount of deionized water of other chemistry applied through module 162, etc., may all be adjusted in response to the identification of a thermal or mechanical stress region. In one embodiment, the adjustments are applied differentially, e.g., to a targeted region of substrate 148. Further details on the interaction of slurry supply module 166, dam control module 164, deionized water or other chemistry module 162, computing device 140, and sensor 160, within the system described with reference to FIG. 12A, may be found in U.S. application Ser. No. 10/463,526 which has been incorporated by reference in its entirety for all purposes.

In another embodiment of the invention, the support supplied by air bearing platen 168 is responsive to the analysis of the stress map. For example, if the stress map indicates regions having a high mechanical stress, the resistance to the downforce that is supplied by platen 168 may be decreased. It should be appreciated that the resistance may be decreased in a differential manner. That is, the resistance may be decreased in one portion of the region supported by platen 168, while another portion of the region maintains an increased resistance. Likewise, if a high temperature stress region is identified the resistance offered by platen 168 may be decreased in order to reduce the temperature. Here again, the resistance may be adjusted differentially.

FIG. 12B is a simplified schematic diagram of an alternative embodiment of the chemical mechanical planarization system of FIG. 12A. Here, rather than utilizing a rigid dam to impede the flow of fluid deposited on polishing pad 150 from slurry supply module 166, fluid curtain 163 is employed. As with the rigid dam of FIG. 12, fluid curtain 163 creates a barrier that causes slurry lake 167 upstream for the fluid curtain. However, downstream from fluid curtain 163 a smoothed layer of slurry results. It should be appreciated that fluid curtain 163 may be generated from compressed air delivered through a nozzle at a sufficient flow rate and pressure to create the fluid curtain across the width of polishing pad 150. For example, the nozzle may be a long thin nozzle that delivers compressed air to create the fluid curtain. Here, fluid curtain 163 is similar in length to the rigid dam of FIG. 12A. In another embodiment, the nozzle may be a plurality of nozzles extending across the width of the polishing pad that creates the same effect as a continuous fluid curtain on the slurry deposited on the surface of polishing pad 150. It will be apparent one skilled in the art that any suitable fluid, e.g., compressed air, inert gas, etc., compatible with the CMP operation may be used to create fluid curtain 163. The smoothed layer resulting from fluid curtain 163 may then be disrupted to provide differential removal rates to the surface of substrate 148. The disruption results from a fluid such as, deionized water or slurry being delivered to the smoothed layer downstream from fluid curtain 163 from nozzle 169. Deionized water or other chemistry module 162 controls the delivery of the corresponding fluid. Further details on the disruption of the smoothed layer may be in U.S. application Ser. No. 10/463,526 which has been incorporated by reference in its entirety for all purposes.

One skilled in the art will appreciate that the embodiments described herein may be applied as a process development tool. That is, during qualification of a new tool, tests may be run to generate stress maps associated with the processing operations. Thereafter, the tool may be adjusted to process subsequent substrates in a more efficient manner, i.e., without having the high stress region.

In summary, the present invention provides for the generation and analysis of a stress map associated with a substrate being processed during a semiconductor processing operation. A proximity sensor, e.g., an eddy current sensor, is used to detect a signal associated with a level of mechanical stress being experienced at a location on the substrate. A temperature sensor, e.g., an infrared sensor, is used to detect a signal associated with thermal stress being experienced at the substrate surface. A stress map is then generated from multiple signals, in one embodiment. Analysis of the stress map reveals areas of the substrate experiencing stress conditions. Thereafter, corrective action to relieve the stress condition is instituted. For example, if a high temperature or high stress region is located on one portion of the substrate, processing parameters may be adjusted differentially to relieve the stress at the corresponding portion of the substrate.

It should be appreciated that while the embodiments have been described in terms of a CMP process, the embodiments are not limited to a CMP process. For example, the sensors may be used within any semiconductor process that removes or deposits a layer or film on a substrate, such as etch, deposition and photoresist stripping processes. Furthermore, the above described embodiments may be applied to rotary or orbital type CMP systems as well as the belt type CMP system.

The embodiments described herein also provide for a CMP system that is configured to differentially control removal rates being applied to regions of a wafer. The differential control enables for a uniform thickness to be obtained as opposed to a uniform removal rate. The differential control additionally allows for identified portions of the substrate having a high stress condition to be targeted for relief.

The invention has been described herein in terms of several exemplary embodiments. Other embodiments of the invention will be apparent to those skilled in the art from consideration of the specification and practice of the invention. The embodiments and preferred features described above should be considered exemplary, with the invention being defined by the appended claims.

1. A chemical mechanical planarization (CMP) system, comprising:
a wafer carrier configured to support a wafer during a planarization process, the wafer carrier including a sensor configured to detect a signal indicating a stress being experienced by the wafer during planarization;
a computing device in communication with the sensor, the computing device configured to translate the signal to generate a stress map for analysis; and
a stress relief device responsive to a signal received from the computing device, the stress relief device configured to relieve the stress being experienced by the wafer.

2. The system of claim 1, includes one of a proximity sensor and a temperature sensor, the proximity sensor configured to detect a signal indicating a mechanical stress, the temperature sensor configured to detect a signal indicating a thermal stress.

3. The system of claim 2, wherein the proximity sensor is an eddy current sensor and the temperature sensor is an infrared sensor.

4. The system of claim 1, wherein the stress relief device is selected from the group consisting of a fluid supply, a platen, and a speed controller.

5. The system of claim 1, wherein the stress relief device is capable of differentially applying a corrective action to relieve the stress.

6. A chemical mechanical planarization (CMP) system capable of monitoring thermal stress associated with a substrate being processed, comprising:
a wafer carrier having a plurality of sensors, each of the plurality of sensors configured to detect a signal corresponding to a temperature of a region of the substrate;
a computing device in communication with the plurality of sensors, the computing device configured to generate a thermal map of the substrate from the signal, the computing device capable of analyzing data associated with the thermal map to identify any region of the substrate experiencing thermal stress; and
a stress relief device responsive to the computing device, wherein the stress relief device is triggered to relieve the thermal stress when the computing device identifies any region of the substrate experiencing thermal stress.

7. The system of claim 6, wherein the computing device includes a signal compensation module configured to account for a signal delay associated with the signal corresponding to the temperature.

8. The system of claim 6, wherein the wafer carrier rotatably supports the substrate over a polishing pad, the polishing pad capable of moving in a linear direction while the wafer rotates.

9. The system of claim 6, wherein the stress relief device includes a fluid supply system capable of delivering a fluid to a portion of a smoothed layer of slurry deposited over a polishing pad, the portion of the smoothed layer associated with one of the any region of the substrate experiencing thermal stress.

10. A chemical mechanical planarization (CMP) system capable of monitoring mechanical stress associated with a substrate being processed, comprising:
a wafer carrier having a sensor configured to detect a signal indicative of a mechanical load experienced by a corresponding location on the substrate during processing;
a computing device in communication with the sensor, the computing device configured to generate a mechanical stress map of the substrate from the signal, the computing device capable of analyzing data associated with the mechanical stress map to identify a region of the substrate experiencing mechanical stress; and
a stress relief device responsive to the computing device, wherein the stress relief device is triggered to relieve the mechanical stress when the computing device identifies any region of the substrate experiencing mechanical stress.

11. The system of claim 10, wherein the wafer carrier rotatably supports the substrate over a polishing pad, the polishing pad capable of moving in a linear direction while the wafer rotates.

12. The system of claim 10, wherein the stress relief device includes a drive motor, the drive motor capable of reducing one of a rotational speed of the wafer carrier and a linear velocity of a polishing pad to relieve the mechanical stress.

13. The system of claim 10, wherein the computing device is a general purpose computer and the stress relief device is one of a drive motor and a platen.

14. A process development tool configured to monitor stress conditions experienced by a substrate during semiconductor processing operations, comprising:
a sensor configured to monitor a signal indicative of a stress experienced by a substrate during processing operations within the process development tool; and
a computing device in communication with the sensor, the computing device configured to create a stress map from the signal, the computing device further configured to analyze the stress map to identify any stressed regions of the substrate so that the computing device may initiate an activity that provides relief to the stressed region.

15. The process development tool of claim 14, wherein the sensor is a proximity sensor configured to detect a distance of a location on a surface of the substrate relative to the sensor.

16. The process development tool of claim 14, wherein the sensor is an infrared sensor configured to detect a temperature associated with a location on a surface of the substrate.

17. A method for monitoring and relieving stress conditions associated with a substrate during a chemical mechanical planarization (CMP) process, comprising:
monitoring a signal corresponding to a stress condition;
generating a stress map corresponding to the substrate from the monitoring of the signal;
analyzing the stress map;
identifying a region of a surface of the substrate experiencing the stress condition; and
adjusting the CMP process to relieve the stress condition.

18. The method of claim 17, wherein the method operation of monitoring a signal corresponding to a stress condition includes,
detecting one of an infrared signal and an eddy current.

19. The method of claim 17, wherein the method operation of generating a stress map corresponding to the substrate from the monitoring of the signal includes,
analyzing an infrared signal;
developing a thermal stress map from the infrared signal; and
aligning the thermal stress map to account for a delay associated with the infrared signal.

20. The method of claim 19, wherein the method operation of aligning the thermal stress map to account for a delay associated with the infrared signal includes,
determining a rotational speed associated with the substrate during the CMP process.

21. The method of claim 17, wherein the method operation of generating a stress map corresponding to the substrate from the monitoring of the signal includes,
analyzing a signal generated from a proximity sensor; and
developing a mechanical stress map from the signal.

22. The method of claim 17, wherein the method operation of adjusting the CMP process to relieve the stress condition includes,
differentially adjusting a process condition to relieve the stress condition at the region.

23. The method of claim 17, wherein the method operation of adjusting the CMP process to relieve the stress condition includes,
disturbing a portion of a substantially uniform slurry layer corresponding to the region experiencing the stress condition.

24. The method of claim 17, wherein the method operation of generating a stress map corresponding to the substrate from the monitoring of the signal includes,
using a rotational modulation component associated with the signal for generating the stress map.
